(19) United States
(12) Patent Application Publication
(10) Pub. No.: US 2026/0215984 A1
(43) Pub. Date: Jul. 30, 2026

(54) OVERHEAD RAIL APPARATUS WITH TRAVERSE SWITCH

(71) Applicant: Liko Research & Development AB, Lulea (SE)

(72) Inventors: Eddy Kerzerho, Ploemel Morbihan (FR); Pierre Lamy, Lorient (FR); Anthony Jöel Thepaut, Lorient (FR)

(73) Assignee: Liko Research & Development AB, Lulea, OT (SE)

(21) Appl. No.: 19/459,003

(22) Filed: Jan. 26, 2026

Related U.S. Application Data
(60) Provisional application No. 63/750,313, filed on Jan. 28, 2025.

(51) Int. Cl. A61G 7/10

(52) U.S. Cl. CPC A61G 7/1042; A61G 7/1051; A61G 7/1065; A61G 2203/30; A61G 2205/00

(57) ABSTRACT

An overhead rail apparatus includes a carriage, a fixed rail, a moveable rail, and a traverse switch. The carriage is configured to support a patient above underlying ground. The fixed rail is configured to be fixed to an overhead structure. The moveable rail is configured to move relative to the fixed rail. The traverse switch is configured to align the moveable rail with the fixed rail so that the carriage can be moved along and between the moveable rail and the fixed rail.

### CROSS-REFERENCE TO RELATED APPLICATIONS

This application claims priority to U.S. Provisional Application No. 63/750,313 filed on Jan. 28, 2025, the entire disclosure of which is incorporated herein by reference.

### BACKGROUND

The present disclosure relates to overhead rail apparatuses that support loads, such as a patient in a care facility, for movement above a floor. More particularly, the present disclosure relates to overhead rail apparatuses having traverse switches that interconnect an end of a moveable rail to an end of a fixed rail in response to alignment of the rails.

Generally, rails of an overhead rail apparatus are aligned by a traverse switch. However, it may be difficult to determine when the rails are properly aligned to allow a carriage supporting a patient to be transported along the rails. If the rails are not properly aligned, the carriage may not properly move between the rails.

Usually, caregivers look upwardly at the traverse switch during alignment of the rails to visually ensure that the rails are aligned. However, this takes the focus of the caregiver away from the patient, and it may be difficult for the caregiver to visually determine if the rails are properly aligned. Thus, providing notice to caregivers regarding the alignment of the traverse switch would be beneficial.

### SUMMARY

An apparatus, system, or method may comprise one or more of the features recited in the appended claims and/or the following features which, alone or in any combination, may comprise patentable subject matter:

According to the present disclosure, an overhead rail apparatus may be provided. The overhead rail apparatus may comprise a carriage, a fixed rail, a moveable rail, and a traverse switch. The carriage may be configured to support a patient above underlying ground. The fixed rail may be configured to be fixed to an overhead structure. The fixed rail may be formed to include a fixed-rail channel configured to receive the carriage therein so that the carriage can be moved along the fixed rail to move the patient. The moveable rail may be configured to move relative to the fixed rail. The moveable rail may be formed to include a moveable-rail channel configured to receive the carriage therein so that the carriage can be moved along the moveable rail to move the patient. The traverse switch may be configured to align the moveable rail with the fixed rail so that the fixed-rail channel is aligned with the moveable-rail channel to form a continuous-carriage channel through which the carriage can be moved. The traverse switch may include a first traverse switch unit coupled to an end of the moveable rail, a second traverse switch unit coupled to an end of the fixed rail, and an indicator unit. The indicator unit may be configured to indicate proper alignment of the moveable rail with the fixed rail by mechanically producing an audible indicator after the moveable rail is aligned with the fixed rail so that the carriage can be moved along the continuous-carriage channel to move the patient.

Optionally, the first traverse switch unit may include a first housing coupled to the end of the moveable rail and a first cover coupled to the first housing to locate the first housing between the first cover and the end of the moveable rail. The first housing may be formed to define a first switch channel that is aligned with the moveable-rail channel. The second traverse switch unit may include a second housing coupled to the end of the fixed rail and a second cover coupled to the second housing to locate the second housing between the second cover and the end of the fixed rail. The second housing may be formed to define a second switch channel that is aligned with the fixed-rail channel.

Further optionally, the indicator unit may be coupled to the first housing and located between the first housing and the first cover. The indicator unit may include a sound bracket, a lever assembly, and a first spring interconnecting the sound bracket and the lever assembly. The lever assembly may include a lever configured to pivot about a lever-pivot axis, a roller coupled to the lever and configured to move linearly to cause the lever to pivot, and a second spring coupled to the lever and the first housing and configured to urge the lever to pivot about the lever-pivot axis.

If desired, the lever may be fixed to the first housing at a first end thereof and configured to pivot about the lever-pivot axis relative to the first housing and the first cover such that a second end of the lever opposite the first end pivots. The second cover of the second traverse switch unit may be formed to include a first recess extending into the second cover toward the second housing. The first recess may have a first ramped portion, a second ramped portion, and a trough located between the first ramped portion and the second ramped portion.

Alternatively, the lever may pivot about the lever-pivot axis in a first direction in response to engagement of the roller of the lever assembly with the first ramped portion of the first recess of the second traverse switch unit to cause the roller to move vertically upwardly. The lever may pivot about the lever-pivot axis in a second direction opposite the first direction in response to engagement of the roller of the lever assembly with the trough of the first recess of the second traverse switch unit to cause the roller to move vertically downwardly. The sound bracket may be configured to pivot in the second direction about a bracket-pivot axis in response to pivoting of the lever about the lever-pivot axis in the first direction. The first spring may urge the sound bracket to pivot in the second direction.

Additionally, the sound bracket may be configured to pivot in the first direction about the bracket-pivot axis in response to pivoting of the lever about the lever-pivot axis in the second direction. In response to pivoting of the sound bracket in the first direction, a lower end of the sound bracket may contact the first housing of the first traverse switch unit to produce the audible indicator.

Optionally, the first traverse switch unit may further include a first carriage blocker configured to block movement of the carriage out of the moveable-rail channel while the moveable rail and the fixed rail are not properly aligned. The first carriage blocker may include a pin configured to extend downwardly into the first switch channel to block movement of the carriage out of the moveable-rail channel while the moveable rail and the fixed rail are not properly aligned and a roller coupled to the pin of the first carriage blocker and configured to move the pin of the first carriage blocker upwardly out of the first switch channel so that the carriage is free to move out of the moveable-rail channel and into the first switch channel while the moveable rail and the fixed rail are properly aligned.

Further optionally, the roller of the first carriage blocker may move upwardly with the pin of the first carriage blocker in response to engagement of the roller of the first carriage blocker with the second cover of the second traverse switch unit. The second cover may be formed to include a second recess extending into the second cover toward the second housing. The second recess may have a first ramped portion, a second ramped portion, and a peak located between the first ramped portion of the second recess and the second ramped portion of the second recess. In response to movement of the moveable rail relative to the fixed rail, the roller of the first carriage blocker may move along the first ramped portion of the second recess of the second cover to the peak of the second recess of the second cover to move the pin of the first carriage blocker upwardly out of the first switch channel.

If desired, the first cover may be formed to include a recess extending into the first cover toward the first housing. The recess may have a first ramped portion, a second ramped portion, and a peak located between the first ramped portion and the second ramped portion. The second traverse switch unit may further include a second carriage blocker configured to block movement of the carriage out of the fixed-rail channel while the moveable rail and the fixed rail are not properly aligned. The second carriage blocker may include a pin configured to extend downwardly into the second switch channel to block movement of the carriage out of the fixed-rail channel while the moveable rail and the fixed rail are not properly aligned and a roller coupled to the pin of the second carriage blocker and configured to move the pin of the second carriage blocker upwardly out of the second switch channel so that the carriage is free to move out of the fixed-rail channel and into the second switch channel while the moveable rail and the fixed rail are properly aligned.

Alternatively, the roller of the second carriage blocker may move upwardly with the pin of the second carriage blocker in response to engagement of the roller of the second carriage blocker with the first cover of the first traverse switch unit. In response to movement of the moveable rail relative to the fixed rail, the roller of the second carriage blocker may move along the first ramped portion of the recess of the first cover to the peak of the recess of the first cover to move the pin of the second carriage blocker upwardly out of the second switch channel.

Additionally, the overhead rail apparatus may further comprise a first fixation bracket configured to couple the first traverse switch unit to the end of the moveable rail. The first fixation bracket may include a body, a plurality of fasteners configured to extend through the body, and a rail coupler extending downwardly from the body. The first housing of the first traverse switch unit may be formed to include a rail-receiving space located on an opposite side of the first housing than the first cover. The rail-receiving space may be configured to receive the end of the moveable rail therein. The moveable rail may be formed to include a fixation-bracket channel located above the moveable-rail channel. The fixation-bracket channel may be configured to receive the rail coupler of the first fixation bracket therein to secure the first fixation bracket to the moveable rail.

Optionally, the first traverse switch unit may include a first flange extending outwardly from the first housing in a direction opposite the first cover and a second flange spaced apart from the first flange and extending outwardly from the first housing in the direction opposite the first cover. The body of the first fixation bracket may engage the first flange and the second flange. The plurality of fasteners may extend through the first flange and the body and the second flange and the body to couple the first fixation bracket to the first traverse switch unit.

Further optionally, the overhead rail apparatus may further comprise a second fixation bracket configured to couple the second traverse switch unit to the end of the fixed rail. The second fixation bracket may include a body, a plurality of fasteners configured to extend through the body, and a rail coupler extending downwardly from the body. The second housing of the second traverse switch unit may be formed to include a rail-receiving space located on an opposite side of the second housing than the second cover. The rail-receiving space may be configured to receive the end of the fixed rail therein.

If desired, the fixed rail may be formed to include a fixation-bracket channel located above the fixed-rail channel. The fixation-bracket channel may be configured to receive the rail coupler of the second fixation bracket therein to secure the second fixation bracket to the fixed rail. The second traverse switch unit may include a first flange extending outwardly from the second housing in a direction opposite the second cover and a second flange spaced apart from the first flange and extending outwardly from the second housing in the direction opposite the second cover. The body of the second fixation bracket may engage the first flange and the second flange. The plurality of fasteners may extend through the first flange and the body and the second flange and the body to couple the second fixation bracket to the second traverse switch unit.

Further according to the present disclosure, an overhead rail apparatus may be provided. The overhead rail apparatus may comprise a fixed rail, a moveable rail, and a traverse switch. The fixed rail may be configured to be fixed to an overhead structure. The moveable rail may be configured to move relative to the fixed rail. The traverse switch may be configured to align the moveable rail with the fixed rail. The traverse switch may include a first traverse switch unit coupled to an end of the moveable rail, a second traverse switch unit coupled to an end of the fixed rail, and an indicator unit configured to indicate proper alignment of the moveable rail with the fixed rail by mechanically producing an audible indicator after the moveable rail is aligned with the fixed rail. The indicator unit may include a sound bracket configured to pivot about a bracket-pivot axis to produce the audible indicator and a lever assembly configured to pivot about a lever-pivot axis to cause the sound bracket to pivot about the bracket-pivot axis.

Optionally, the first traverse switch unit may include a first housing coupled to the end of the moveable rail and a first cover coupled to the first housing to locate the first housing between the first cover and the end of the moveable rail. The second traverse switch unit may include a second housing coupled to the end of the fixed rail and a second cover coupled to the second housing to locate the second housing between the second cover and the end of the fixed rail. The indicator unit may be coupled to the first housing and located between the first housing and the first cover. The lever assembly may include a lever configured to pivot about the lever-pivot axis, a roller coupled to the lever and configured to move linearly to cause the lever to pivot, and a spring coupled to the lever and the first housing and configured to urge the lever to pivot about the lever-pivot axis.

Further optionally, the lever may be fixed to the first housing at a first end thereof and configured to pivot about the lever-pivot axis relative to the first housing and the first cover such that a second end of the lever opposite the first end pivots. The second cover of the second traverse switch unit may be formed to include a first recess extending into the second cover toward the second housing. The first recess may have a first ramped portion, a second ramped portion, and a trough located between the first ramped portion and the second ramped portion.

If desired, the lever may pivot about the lever-pivot axis in a first direction in response to engagement of the roller of the lever assembly with the first ramped portion of the first recess of the second traverse switch unit to cause the roller to move vertically upwardly. The lever may pivot about the lever-pivot axis in a second direction opposite the first direction in response to engagement of the roller of the lever assembly with the trough of the first recess of the second traverse switch unit to cause the roller to move vertically downwardly. The sound bracket may be configured to pivot in the second direction about the bracket-pivot axis in response to the lever pivoting about the lever-pivot axis in the first direction.

Alternatively, the indicator unit may further include a spring interconnecting the sound bracket and the lever. The spring of the indicator unit may be configured to urge the sound bracket to pivot in the second direction. The sound bracket may be configured to pivot in the first direction about the bracket-pivot axis in response to the lever pivoting about the lever-pivot axis in the second direction. In response to the sound bracket pivoting in the first direction, a lower end of the sound bracket may contact the first housing of the first traverse switch unit to produce the audible indicator.

Additionally, the first traverse switch unit may further include a first carriage blocker configured to block movement of a carriage while the moveable rail and the fixed rail are not properly aligned. The first carriage blocker may include a pin configured to extend downwardly below a bottom surface of the first housing to block movement of the carriage while the moveable rail and the fixed rail are not properly aligned and a roller coupled to the pin of the first carriage blocker and configured to move the pin of the first carriage blocker upwardly so that the pin does not extend below the bottom surface of the first housing so that the carriage is free to move while the moveable rail and the fixed rail are properly aligned. The roller of the first carriage blocker may move upwardly with the pin of the first carriage blocker in response to engagement of the roller of the first carriage blocker with the second cover of the second traverse switch unit.

Optionally, the second cover may be formed to include a second recess extending into the second cover toward the second housing. The second recess may have a first ramped portion, a second ramped portion, and a peak located between the first ramped portion of the second recess and the second ramped portion of the second recess. In response to movement of the moveable rail relative to the fixed rail, the roller of the first carriage blocker may move along the first ramped portion of the second recess of the second cover to the peak of the second recess of the second cover to move the pin of the first carriage blocker upwardly.

Further optionally, the second traverse switch unit may further include a second carriage blocker configured to block movement of the carriage while the moveable rail and the fixed rail are not properly aligned. The second carriage blocker may include a pin configured to extend downwardly below a bottom surface of the second housing to block movement of the carriage while the moveable rail and the fixed rail are not properly aligned and a roller coupled to the pin of the second carriage blocker and configured to move the pin of the second carriage blocker upwardly so that the pin of the second carriage blocker does not extend below the bottom surface of the second housing so that the carriage is free to move while the moveable rail and the fixed rail are properly aligned. The roller of the second carriage blocker may move upwardly with the pin of the second carriage blocker in response to engagement of the roller of the second carriage blocker with the first cover of the first traverse switch unit.

If desired, the first cover may be formed to include a recess extending into the first cover toward the first housing. The recess may have a first ramped portion, a second ramped portion, and a peak located between the first ramped portion and the second ramped portion. In response to movement of the moveable rail relative to the fixed rail, the roller of the second carriage blocker may move along the first ramped portion of the recess of the first cover to the peak of the recess of the first cover to move the pin of the second carriage blocker upwardly.

Further according to the present disclosure, a method may be provided. The method may include moving a moveable rail along a primary rail toward a fixed rail, aligning a first traverse switch unit coupled to the moveable rail with a second traverse switch unit coupled to the fixed rail, pivoting a lever coupled to the first traverse switch unit about a lever-pivot axis in a first direction, in response to pivoting the lever about the lever-pivot axis in the first direction, pivoting a sound bracket coupled to the first traverse switch unit about a bracket-pivot axis in a second direction opposite the first direction, pivoting the lever about the lever-pivot axis in the second direction, in response to pivoting the lever about the lever-pivot axis in the second direction, pivoting the sound bracket about the bracket-pivot axis in the first direction, and in response to pivoting the sound bracket about the bracket-pivot axis in the first direction, hitting a surface of the first traverse switch unit with the sound bracket to produce an audible indicator.

Optionally, the method may further comprise lifting a pin of a first carriage blocker out of a first switch channel and lifting a pin of a second carriage blocker out of a second switch channel so that a carriage is free to move between the moveable rail and the fixed rail. The step of pivoting a sound bracket coupled to the first traverse switch unit about a bracket-pivot axis in a second direction opposite the first direction may include urging the sound bracket to pivot in the second direction via a first spring.

Further optionally, the step of pivoting the lever about the lever-pivot axis in the second direction may include urging the lever to pivot in the second direction via a second spring. The step of pivoting the sound bracket about the bracket-pivot axis in the first direction may include urging the sound bracket to pivot in the first direction via the first spring. The method may further comprise, after the step of hitting a surface of the first traverse switch unit with the sound bracket to produce an audible indicator, moving a carriage between the moveable rail and the fixed rail. The method may further comprise coupling the first traverse switch unit to the moveable rail via a first fixation bracket and coupling the second traverse switch unit to the fixed rail via a second fixation bracket.

Further according to the present disclosure, an overhead rail apparatus may be provided. The overhead rail apparatus may comprise a carriage, a fixed rail, a moveable rail, and a traverse switch. The carriage may be configured to support a patient above underlying ground. The fixed rail may be configured to be fixed to an overhead structure. The fixed rail may be formed to include a fixed-rail channel configured to receive the carriage therein so that the carriage can be moved along the fixed rail to move the patient. The moveable rail may be configured to move relative to the fixed rail. The moveable rail may be formed to include a moveable-rail channel configured to receive the carriage therein so that the carriage can be moved along the moveable rail to move the patient. The traverse switch may be configured to align the moveable rail with the fixed rail. The traverse switch may include a first traverse switch unit coupled to an end of the moveable rail and having a first switch channel aligned with the moveable-rail channel that is configured to receive the carriage therein, a second traverse switch unit coupled to an end of the fixed rail and having a second switch channel aligned with the fixed-rail channel that is configured to receive the carriage therein, and a carriage blocker unit configured to block movement of the carriage between the moveable-rail channel and the fixed-rail channel while the moveable rail and the fixed rail are not properly aligned by protruding into the first switch channel and the second switch channel and configured to allow for movement of the carriage between the moveable-rail channel and the fixed-rail channel while the moveable rail and the fixed rail are properly aligned by moving out of the first switch channel and the second switch channel so that the moveable-rail channel, the first switch channel, the fixed-rail channel, and the second switch channel form a continuous-carriage channel through which the carriage can be moved.

Optionally, the first traverse switch unit may include a first housing coupled to the end of the moveable rail and a first cover coupled to the first housing to locate the first housing between the first cover and the end of the moveable rail. The second traverse switch unit may include a second housing coupled to the end of the fixed rail and a second cover coupled to the second housing to locate the second housing between the second cover and the end of the fixed rail. The carriage blocker unit may include a first carriage blocker coupled to the first traverse switch unit and configured to block movement of the carriage out of the moveable-rail channel while the moveable rail and the fixed rail are not properly aligned.

Further optionally, the first carriage blocker may include a pin configured to extend downwardly into the first switch channel to block movement of the carriage out of the moveable-rail channel while the moveable rail and the fixed rail are not properly aligned and a roller coupled to the pin of the first carriage blocker and configured to move the pin of the first carriage blocker upwardly out of the first switch channel so that the carriage is free to move out of the moveable-rail channel and into the first switch channel while the moveable rail and the fixed rail are properly aligned. The roller of the first carriage blocker may move upwardly with the pin of the first carriage blocker in response to engagement of the roller of the first carriage blocker with the second cover of the second traverse switch unit.

If desired, the second cover may be formed to include a first recess extending into the second cover toward the second housing. The first recess may have a first ramped portion, a second ramped portion, and a peak located between the first ramped portion of the first recess and the second ramped portion of the first recess. In response to movement of the moveable rail relative to the fixed rail, the roller of the first carriage blocker may move along the first ramped portion of the first recess of the second cover to the peak of the first recess of the second cover to move the pin of the first carriage blocker upwardly out of the first switch channel. The carriage blocker unit may further include a second carriage blocker coupled to the second traverse switch unit and configured to block movement of the carriage out of the fixed-rail channel while the moveable rail and the fixed rail are not properly aligned.

Alternatively, the second carriage blocker may include a pin configured to extend downwardly into the second switch channel to block movement of the carriage out of the fixed-rail channel while the moveable rail and the fixed rail are not properly aligned and a roller coupled to the pin of the second carriage blocker and configured to move the pin of the second carriage blocker upwardly out of the second switch channel so that the carriage is free to move out of the fixed-rail channel and into the second switch channel while the moveable rail and the fixed rail are properly aligned. The roller of the second carriage blocker may move upwardly with the pin of the second carriage blocker in response to engagement of the roller of the second carriage blocker with the first cover of the first traverse switch unit. The first cover may be formed to include a recess extending into the first cover toward the first housing. The recess may have a first ramped portion, a second ramped portion, and a peak located between the first ramped portion and the second ramped portion.

Additionally, in response to movement of the moveable rail relative to the fixed rail, the roller of the second carriage blocker may move along the first ramped portion of the recess of the first cover to the peak of the recess of the first cover to move the pin of the second carriage blocker upwardly out of the second switch channel. The overhead rail apparatus may further comprise an indicator unit configured to indicate proper alignment of the moveable rail with the fixed rail by mechanically producing an audible indicator after the moveable rail is aligned with the fixed rail. The indicator unit may be coupled to the first housing and located between the first housing and the first cover.

Optionally, the indicator unit may include a sound bracket, a lever assembly, and a first spring interconnecting the sound bracket and the lever assembly. The lever assembly may include a lever configured to pivot about a lever-pivot axis, a roller coupled to the lever and configured to move linearly to cause the lever to pivot, and a second spring coupled to the lever and the first housing and configured to urge the lever to pivot about the lever-pivot axis. The lever may be fixed to the first housing at a first end thereof and configured to pivot about the lever-pivot axis relative to the first housing and the first cover such that a second end of the lever opposite the first end pivots.

Further optionally, the second cover of the second traverse switch unit may be formed to include a second recess extending into the second cover toward the second housing. The second recess may have a first ramped portion, a second ramped portion, and a trough located between the first ramped portion and the second ramped portion. The lever may pivot about the lever-pivot axis in a first direction in response to engagement of the roller of the lever assembly with the first ramped portion of the second recess of the second traverse switch unit to cause the roller to move vertically upwardly. The lever may pivot about the lever-pivot axis in a second direction opposite the first direction in response to engagement of the roller of the lever assembly with the trough of the second recess of the second traverse switch unit to cause the roller to move vertically downwardly.

If desired, the sound bracket may be configured to pivot in the second direction about a bracket-pivot axis in response to pivoting of the lever about the lever-pivot axis in the first direction. The first spring may urge the sound bracket to pivot in the second direction. The sound bracket may be configured to pivot in the first direction about the bracket-pivot axis in response to pivoting of the lever about the lever-pivot axis in the second direction. In response to pivoting of the sound bracket in the first direction, a lower end of the sound bracket may contact the first housing of the first traverse switch unit to produce the audible indicator.

Additional features, which alone or in combination with any other feature(s), such as those listed above and/or those listed in the claims, may comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The foregoing and other features of the various embodiments of the methods and apparatuses described herein will become more apparent from the following detailed description and the accompanying drawings in which:

FIG. 1 is a perspective view of an overhead rail apparatus configured to move a patient within an open area, the overhead rail apparatus including a plurality of primary rails fixed to an overhead structure, a fixed rail perpendicular to the plurality of primary rails, a moveable rail perpendicular to the plurality of primary rails and moveable along the plurality of primary rails toward the fixed rail, a traverse switch including units coupled to the moveable rail and the fixed rail and configured to mate to align the moveable rail and the fixed rail, and a carriage coupled to the moveable rail and having a sling bar and a sling suspended thereunder to support the patient and move along the moveable and fixed rails while the moveable and fixed rails are aligned via the traverse switch;

FIG. 2 is a perspective view of a first traverse switch unit included in the traverse switch of FIG. 1, the first traverse switch unit configured to be coupled with an end of the moveable rail, as shown in FIG. 1, and formed to include a recess that extends into the first traverse switch unit, the recess having a first ramped portion, a second ramped portion, and a peak located between the first ramped portion and the second ramped portion;

FIG. 3 is a perspective view of a second traverse switch unit included in the traverse switch of FIG. 1, the second traverse switch unit configured to be coupled with an end of the fixed rail, as shown in FIG. 1, and formed to include a first recess and a second recess that both extend into the second traverse switch unit, the first recess having a first ramped portion, a second ramped portion, and a peak located between the first ramped portion and the second ramped portion and the second recess having a first ramped portion, a second ramped portion, and a trough located between the first ramped portion and the second ramped portion;

FIG. 4 is a perspective view of the first traverse switch unit of FIG. 2 with a portion removed showing that the first traverse switch unit includes a first carriage blocker that extends downwardly into a first switch channel to block movement of the carriage while the moveable rail and the fixed rail are not properly aligned, and further showing that the traverse switch further includes an indictor unit that indicates proper alignment of the moveable rail and the fixed rail by mechanically producing an audible indicator, the indicator unit including a lever assembly, a sound bracket configured to pivot to produce the audible indicator, and a spring interconnecting the lever assembly and the sound bracket;

FIG. 5 is a perspective view of the second traverse switch unit of FIG. 3 with a portion removed showing that the second traverse switch unit includes a second carriage blocker that extends downwardly into a second switch channel to block movement of the carriage while the moveable rail and the fixed rail are not properly aligned;

FIG. 6 shows a first step in an alignment sequence of the moveable rail with the fixed rail in which the first traverse switch unit moves to the left toward the second traverse switch unit so that a roller of the first carriage blocker moves along the first recess of the second traverse switch unit and a roller of the lever assembly moves along the second recess of the second traverse switch unit;

FIG. 7 shows a second step in the alignment sequence of the moveable rail with the fixed rail in which the roller of the first carriage blocker continues to move along the first recess of the second traverse switch unit to move a pin of the first carriage blocker upwardly out of the first switch channel and the roller of the lever assembly continues to move along the second recess of the second traverse switch unit to cause a lever of the lever assembly to pivot in a clockwise direction;

FIG. 8 shows a third step in the alignment sequence of the moveable rail with the fixed rail in which the pivoting of the lever of the lever assembly causes the sound bracket to pivot in a counterclockwise direction;

FIG. 9 shows a fourth step in the alignment sequence of the moveable rail with the fixed rail in which the roller of the first carriage blocker moves to the peak of the first recess of the second traverse switch unit to move the pin of the first carriage blocker upwardly out of the first switch channel and the roller of the lever assembly begins to move into the trough of the second recess of the second traverse switch unit to cause the lever of the lever assembly to pivot in a counterclockwise direction;

FIG. 10 shows a fifth step in the alignment sequence of the moveable rail with the fixed rail in which the roller of the lever assembly moves into the trough of the second recess of the second traverse switch unit to cause the lever of the lever assembly to pivot in the counterclockwise direction, which causes the sound bracket to pivot in a clockwise direction to contact the first traverse switch unit to produce the audible indicator;

FIG. 11 is an enlarged view of a circled region of FIG. 8 with the second traverse switch unit removed showing that, in the third step in the alignment sequence, the sound bracket pivots in the counterclockwise direction to engage the first traverse switch unit without producing an audible indicator;

FIG. 12 is an enlarged view of a circled region of FIG. 10 with the second traverse switch unit removed showing that, in the fifth step in the alignment sequence, the sound bracket pivots in the clockwise direction to contact the first traverse switch unit to produce the audible indicator;

FIG. 13 is a perspective view of the second traverse switch unit of FIG. 3 showing that the second traverse switch unit is formed to include a rail-receiving space located on an opposite side of the second traverse switch unit than the first and second recesses, the rail-receiving space receives the end of the fixed rail therein, as shown in FIG. 1;

FIG. 14 is a perspective view of a fixation bracket configured to couple one of the traverse switch units to the fixed rail or the moveable rail, as shown in FIG. 1;

FIG. 15 is a perspective view of the fixation bracket coupled to the second traverse switch unit and the fixed rail showing that the fixation bracket includes a body, a plurality of fasteners that extends through the body and the second traverse switch unit, and a rail coupler that extends downwardly from the body to engage the fixed rail; and

FIG. 16 is a perspective view of an alternative fixation bracket configured to couple the first traverse switch unit with an alternative moveable rail having a greater height than the moveable rail of FIG. 1.

### DETAILED DESCRIPTION

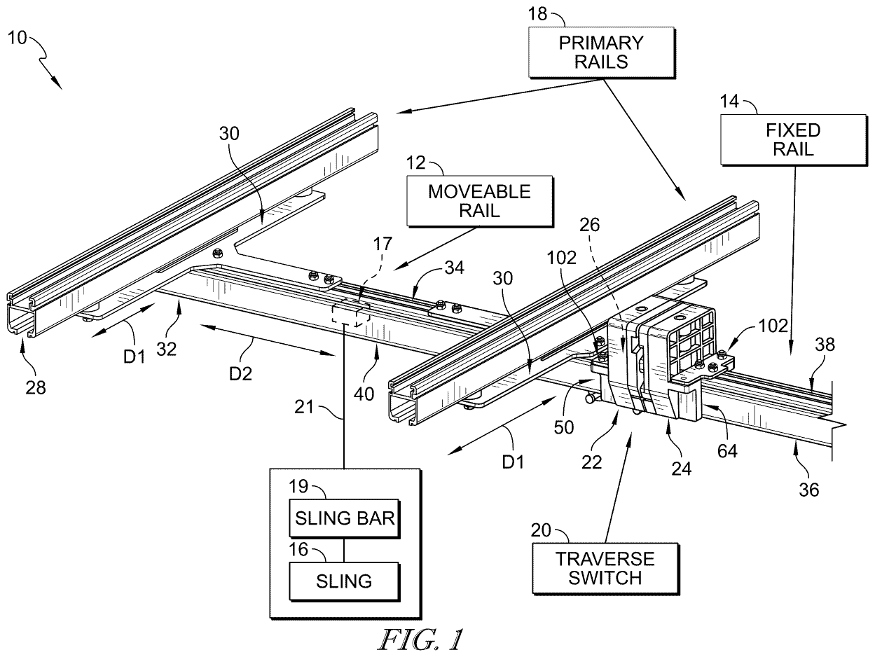

The present disclosure relates to an overhead rail apparatus 10 that provides notice to caregivers regarding an alignment of a moveable rail 12 and a fixed rail 14. The overhead rail apparatus 10 allows for movement of a patient supported by a sling 16 throughout an open area, as suggested in FIG. 1. The sling 16 is illustratively coupled to a sling bar 19, and the sling bar 19 is coupled to a strap 21. The strap 21 extends between and interconnects the sling bar 19 and a carriage 17. The carriage 17 engages the moveable rail 12 and the fixed rail 14 to move along the moveable rail 12 and the fixed rail 14. The movement of the patient may include raising or lowering the patient into and out of a bed or a chair. For example, the carriage 17 may include a winch (not shown) for extending and retracting the strap 21 to raise and lower, respectively, the sling bar 19 and the sling 16. The movement of the patient may include horizontal movement along the moveable rail 12 and the fixed rail 14, as suggested in FIG. 1, or vertical movement relative to the rails 12, 14. The carriage 17 may slide along the rails 12, 14 via manual movement by a caregiver or the carriage 17 may slide along the rails 12, 14 via a controlled mechanism.

The overhead rail apparatus 10 includes a plurality of primary rails 18, at least one fixed rail 14, and at least one moveable rail 12, as shown in FIG. 1. Each of the plurality of primary rails 18 are parallel to one another, and the fixed and moveable rails 12, 14 are perpendicular to the plurality of primary rails 18. The primary rails 18 are fixed to an overhead structure, such as a ceiling. The fixed rail 14 is also fixed to the overhead structure. The moveable rail 12 moves along the primary rails 18 in a first direction D1 so that the moveable rail 12 and the fixed rail 14 can be aligned with one another, as shown in FIG. 1. Once the moveable rail 12 and the fixed rail 14 are properly aligned with one another, the carriage 17 can be moved in a second direction D2 along and between the moveable rail 12 and the fixed rail 14, as shown in FIG. 1.

The overhead rail apparatus 10 further includes a traverse switch 20, as shown in FIG. 1. The traverse switch 20 is configured to align the moveable rail 12 and the fixed rail 14 so that the carriage 17 can be moved therebetween. Illustratively, the traverse switch 20 includes a first traverse switch unit 22 and a second traverse switch unit 24. In some embodiments, the first traverse switch unit 22 is coupled to an end of the moveable rail 12, and the second traverse switch unit 24 is coupled to an end of the fixed rail 14, as shown in FIG. 1. As the moveable rail 12 moves toward the fixed rail 14, the first traverse switch unit 22 aligns with the second traverse switch unit 24. In some embodiments, the first traverse switch unit 22 is coupled to the end of the fixed rail 14, and the second traverse switch unit 24 is coupled to the end of the moveable rail 12.

In traditional overhead rail apparatuses, caregivers look upwardly at the traverse switch to ensure alignment of the moveable rail and the fixed rail. Thus, caregivers determine alignment by visually looking at the traverse switch. Having the caregiver look upwardly at the traverse switch takes the caregiver's focus away from the patient.

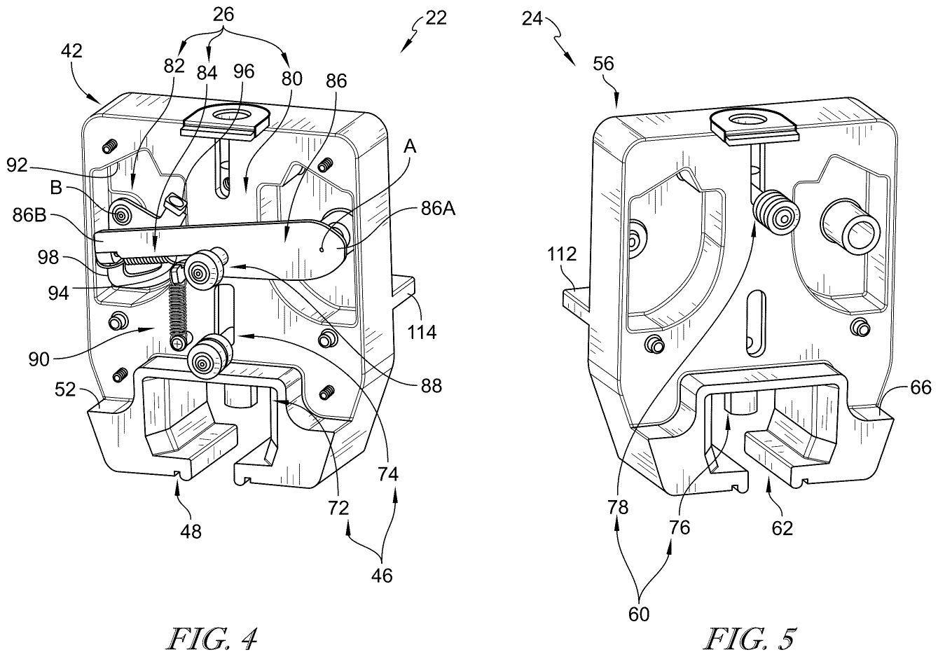

Thus, the traverse switch 20 includes an indicator unit 26, as shown in FIG. 4, configured to indicate proper alignment of the moveable rail 12 and the fixed rail 14 by mechanically producing an audible indicator after the moveable rail 12 is aligned with the fixed rail 14 so that the carriage 17 can be moved along the rails 12, 14. The indicator unit 26 provides clear feedback to the caregiver regarding the alignment without requiring the caregiver to look upwardly at the traverse switch 20 and away from the patient. The audible indicator provides confidence to the caregiver that the traverse switch 20 has been properly aligned so that the caregiver may proceed with safely moving the carriage 17, and thus, the patient, between the rails 12, 14.

Turning back to the plurality of primary rails 18, each of the plurality of primary rails 18 is formed to include a carrier-receiving channel 28 that extends upwardly into the primary rail 18, as shown in FIG. 1. Each of the carrier-receiving channels 28 is configured to receive a rail carrier 30 therein. The rail carrier 30 is fixed to the moveable rail 12 and configured to slide within the carrier-receiving channel 28 to move the moveable rail 12 along the primary rails 18.

The moveable rail 12 is formed to include a moveable-rail channel 32, as shown in FIG. 1, that extends upwardly into the moveable rail 12. The moveable-rail channel 32 receives the carriage 17 therein so that the carriage 17 can slide within the moveable-rail channel 32 to move the carriage 17 and the patient. The moveable rail 12 is also formed to include a fixation-bracket channel 34, as shown in FIG. 1. The fixation-bracket channel 34 extends downwardly into the moveable rail 12 opposite the moveable-rail channel 32. As discussed in more detail below, the fixation-bracket channel 34 receives a portion of a fixation bracket 102 therein to couple the first traverse switch unit 22 to the moveable rail 12, as shown in FIG. 1.

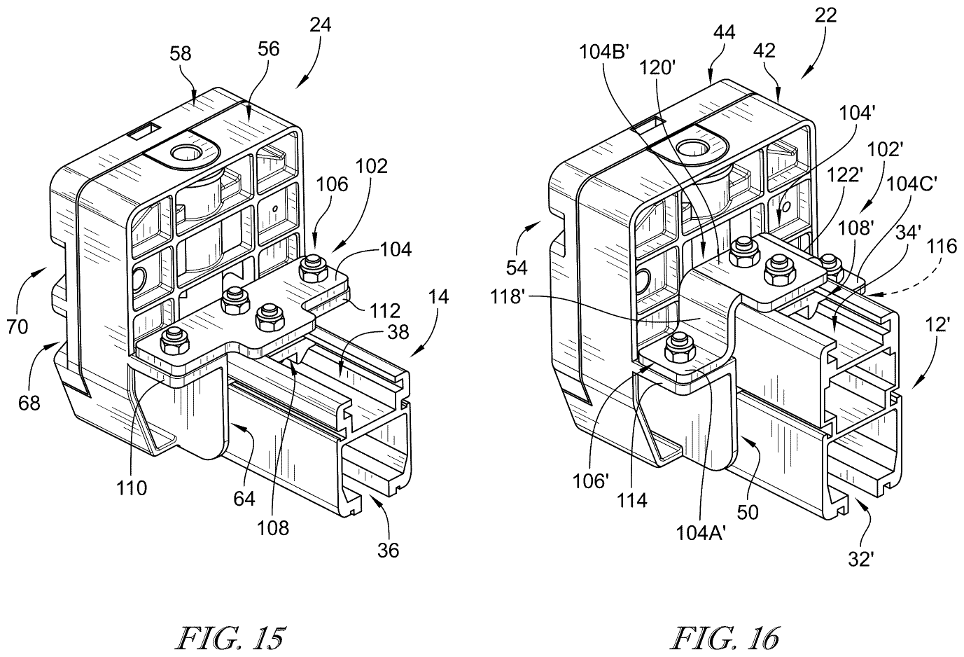

The fixed rail 14 is formed to include a fixed-rail channel 36, as shown in FIGS. 1 and 15, that extends upwardly into the fixed rail 14. The fixed-rail channel 36 receives the carriage 17 therein so that the carriage 17 can slide within the fixed-rail channel 36 to move the carriage 17 and the patient. The fixed rail 14 is also formed to include a fixation-bracket channel 38, as shown in FIGS. 1 and 15. The fixation-bracket channel 38 extends downwardly into the fixed rail 14 opposite the fixed-rail channel 36. As discussed in more detail below, the fixation-bracket channel 38 receives a portion of a fixation bracket 102 therein to couple the second traverse switch unit 24 to the fixed rail 14.

The traverse switch 20 is configured to align the moveable rail 12 with the fixed rail 14 so that the fixed-rail channel 36 is aligned with the moveable-rail channel 32 to form a continuous-carriage channel 40 through which the carriage 17 can be moved, as shown in FIG. 1. The traverse switch 20 includes the first traverse switch unit 22, the second traverse switch unit 24, and the indicator unit 26.

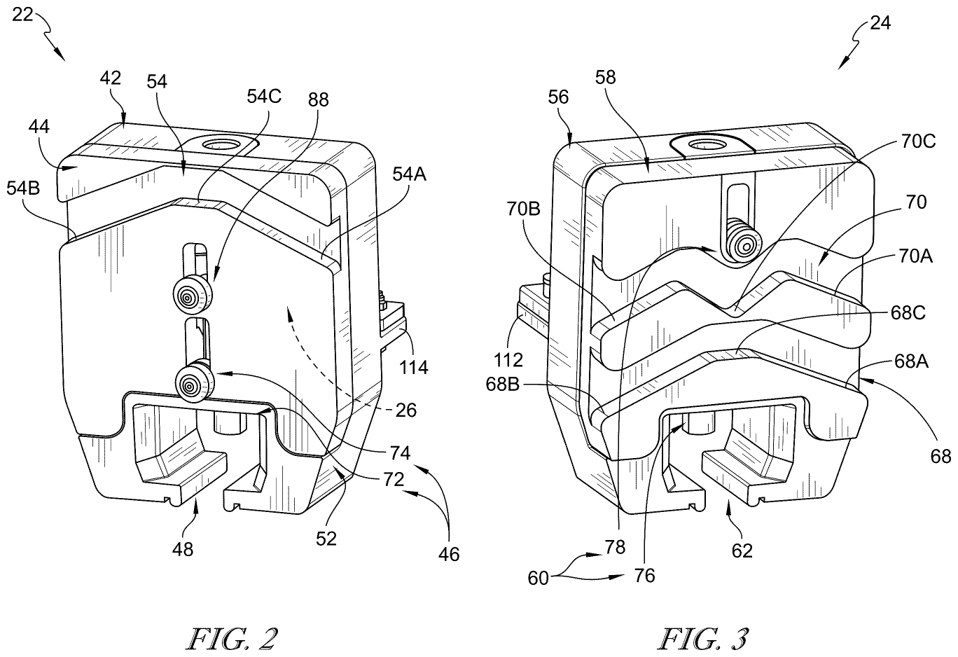

The first traverse switch unit 22, as shown in FIGS. 2 and 4, includes a first housing 42, a first cover 44, and a first carriage blocker 46. The first housing 42 is coupled to the end of the moveable rail 12, as shown in FIG. 1. The first cover 44 is coupled to the first housing 42 to locate the first housing 42 between the first cover 44 and the end of the moveable rail 12. In this way, the first cover 44 faces toward the second traverse switch unit 24. The first carriage blocker 46 is configured to block movement of the carriage 17 out of the moveable-rail channel 32 while the moveable rail 12 and the fixed rail 14 are not properly aligned.

The first housing 42 is formed to define a first switch channel 48 extending upwardly into the first housing 42, as shown in FIGS. 2 and 4. The first switch channel 48 is aligned with the moveable-rail channel 32 so that the carriage 17 can slide between the moveable-rail channel 32, the first switch channel 48, and the fixed-rail channel 36. The first housing 42 is further formed to include a rail-receiving space 50 located on an opposite side of the first housing 42 than the first cover 44, as shown in FIG. 1. The rail-receiving space 50 receives the end of the moveable rail 12 therein.

The first cover 44 is coupled to the first housing 42, as shown in FIG. 2. The first traverse switch unit 22 with the first cover 44 removed is shown in FIG. 4. The first cover 44 is received in a cavity 52 of the first housing 42, as suggested in FIG. 4. The first cover 44 is formed to include a recess 54 extending into the first cover 44 toward the first housing 42, as shown in FIG. 2. The recess 54 faces toward the second traverse switch unit 24. The recess 54 has a first ramped portion 54A, a second ramped portion 54B, and a peak 54C. The peak 54C is located between the first ramped portion 54A and the second ramped portion 54B. The first ramped portion 54A slopes upwardly from a first edge of the first cover 44 to the peak 54C. The second ramped portion 54B slopes downwardly from the peak 54C to a second edge of the first cover 44 opposite the first edge. The recess 54 resembles a somewhat chevron-shaped or upside-down V-shaped channel.

The second traverse switch unit 24, as shown in FIGS. 3 and 5, includes a second housing 56, a second cover 58, and a second carriage blocker 60. The second housing 56 is coupled to the end of the fixed rail 14, as shown in FIG. 1. The second cover 58 is coupled to the second housing 56 to locate the second housing 56 between the second cover 58 and the end of the fixed rail 14. In this way, the second cover 58 faces toward the first traverse switch unit 22. The second carriage blocker 60 is configured to block movement of the carriage 17 out of the fixed-rail channel 36 while the moveable rail 12 and the fixed rail 14 are not properly aligned.

The second housing 56 is formed to define a second switch channel 62 extending upwardly into the second housing 56, as shown in FIGS. 3 and 5. The second switch channel 62 is aligned with the fixed-rail channel 36 so that the carriage 17 can slide between the fixed-rail channel 36, the second switch channel 62, and the first switch channel 48. The second housing 56 is further formed to include a rail-receiving space 64 located on an opposite side of the second housing 56 than the second cover 58, as shown in FIG. 1. The rail-receiving space 64 receives the end of the fixed rail 14 therein.

The second cover 58 is coupled to the second housing 56, as shown in FIG. 3. The second traverse switch unit 24 with the second cover 58 removed is shown in FIG. 5. The second cover 58 is received in a cavity 66 of the second housing 56, as suggested in FIG. 5. The second cover 58 is formed to include a first recess 68 extending into the second cover 58 toward the second housing 56, as shown in FIG. 3. The first recess 68 has a first ramped portion 68A, a second ramped portion 68B, and a peak 68C. The peak 68C is located between the first ramped portion 68A and the second ramped portion 68B. The first ramped portion 68A slopes upwardly from a first edge of the second cover 58 to the peak 68C. The second ramped portion 68B slopes downwardly from the peak 68C to a second end of the second cover 58 opposite the first end. Thus, similar to the recess 54, the recess 68 resembles a somewhat chevron-shaped or upside-down V-shaped channel.

The second cover 58 is further formed to include a second recess 70 extending into the second cover 58 toward the second housing 56, as shown in FIG. 3. The first recess 68 and the second recess 70 both face toward the first traverse switch unit 22. The second recess 70 is located above the first recess 68. The second recess 70 has a first ramped portion 70A, a second ramped portion 70B, and a trough 70C. The trough 70C is located between the first ramped portion 70A and the second ramped portion 70B. The first ramped portion 70A slopes upwardly from the first edge of the second cover 58 to the trough 70C. The second ramped portion 70B slopes downwardly from the trough 70C to the second edge of the second cover 58. The recess 70 resembles a somewhat M-shaped channel.

Turning back to the first carriage blocker 46 of the first traverse switch unit 22, the first carriage blocker 46 includes a pin 72 and a roller 74, as shown in FIGS. 2 and 4. The pin 72 extends downwardly into the first switch channel 48, as shown in FIG. 2, to block movement of the carriage 17 out of the moveable-rail channel 32 while the moveable rail 12 and the fixed rail 14 are not properly aligned. Without the pin 72, the carriage 17 may fall out of the moveable-rail channel 32 while the moveable rail 12 and the fixed rail 14 are not properly aligned.

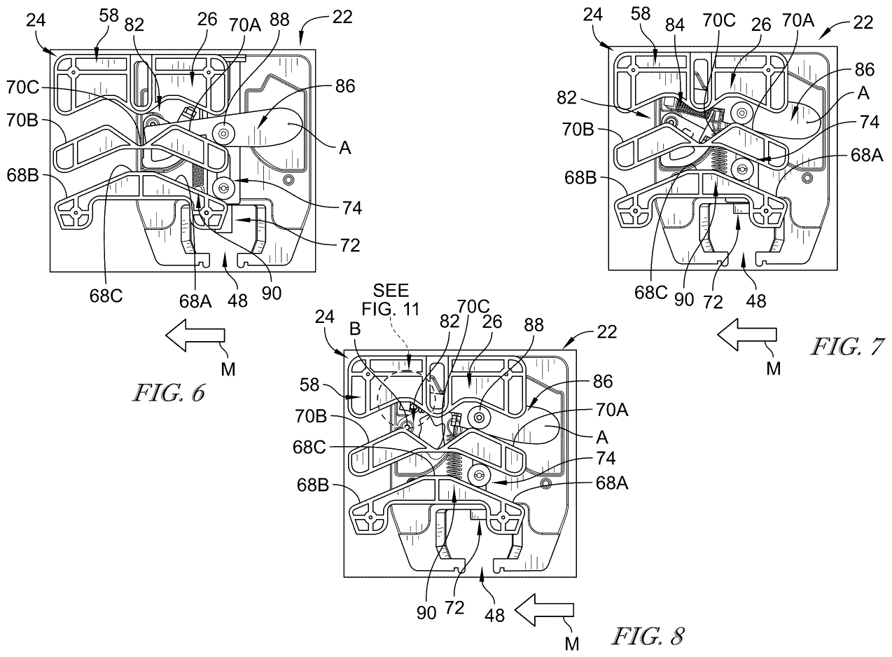

The roller 74 is coupled to the pin 72 and configured to move upwardly to move the pin 72 out of the first switch channel 48, as suggested in FIGS. 6-10. The roller 74 is coupled to a top end of the pin 72. The roller 74 extends outwardly through a slot formed in the first housing 42 and through a slot formed in the first cover 44, as shown in FIGS. 2 and 4. The roller 74 moves upwardly and downwardly within these slots to move the pin 72 upwardly and downwardly.

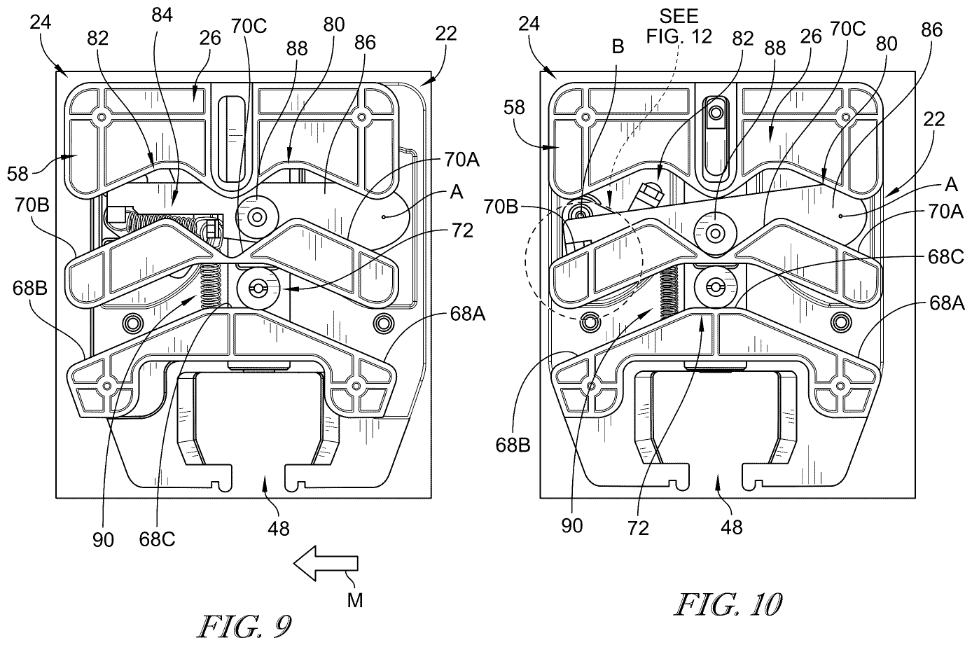

While the fixed rail 14 and the moveable rail 12 are not aligned, the pin 72 extends downwardly into the first switch channel 48, as shown in FIGS. 2 and 6-8. As the moveable rail 12 and the first traverse switch unit 22 are moved toward the fixed rail 14 and the second traverse switch unit 24 in a movement direction M, the roller 74 slides along the first recess 68 of the second cover 58 of the second traverse switch unit 24. As shown in FIGS. 6-8, as the first traverse switch unit 22 is moved toward the second traverse switch unit 24 in the movement direction M, the roller 74 slides up the first ramped portion 68A of the first recess 68. As the roller 74 slides up the first ramped portion 68A, the pin 72 moves upwardly within the first switch channel 48. The roller 74 continues to slide up the first ramped portion 68A until the roller 74 slides onto the peak 68C of the first recess 68. The roller 74 is located on the peak 68C once the first traverse switch unit 22 and the second traverse switch unit 24 are aligned. As shown in FIGS. 9 and 10, once the roller 74 is located on the peak 68C, the pin 72 is lifted entirely out of the first switch channel 48. After the pin 72 is lifted entirely out of the first switch channel 48, the carriage 17 is free to move through the first switch channel 48.

The moveable rail 12 and the first traverse switch unit 22 may then be moved away from the fixed rail 14 and the second traverse switch unit 24 in the movement direction M. During this movement, the roller 74 slides down the second ramped portion 68B of the first recess 68 from the peak 68C. The pin 72 then moves downwardly back into the first switch channel 48.

The second carriage blocker 60 of the second traverse switch unit 24 operates similarly to the first carriage blocker 46 of the first traverse switch unit 22. The second carriage blocker 60 includes a pin 76 and a roller 78, as shown in FIGS. 3 and 5. The pin 76 extends downwardly into the second switch channel 62, as shown in FIG. 3, to block movement of the carriage 17 out of the fixed-rail channel 36 while the moveable rail 12 and the fixed rail 14 are not properly aligned. Without the pin 76, the carriage 17 may fall out of the fixed-rail channel 36 while the moveable rail 12 and the fixed rail 14 are not properly aligned.

The roller 78 is coupled to the pin 76 and configured to move upwardly to move the pin 76 out of the second switch channel 62. The roller 78 extends outwardly through a slot formed in the second housing 56 and through a slot formed in the second cover 58, as shown in FIGS. 3 and 5. The roller 78 moves upwardly and downwardly within these slots to move the pin 76 upwardly and downwardly.

While the fixed rail 14 and the moveable rail 12 are not aligned, the pin 76 extends downwardly into the second switch channel 62, as shown in FIG. 2. As the moveable rail 12 and the first traverse switch unit 22 are moved toward the fixed rail 14 and the second traverse switch unit 24 in the movement direction M, the roller 78 slides along the recess 54 of the first cover 44 of the first traverse switch unit 22, as suggested in FIGS. 2 and 3. As the first traverse switch unit 22 is moved toward the second traverse switch unit 24, the roller 78 slides up the first ramped portion 54A of the recess 54. As the roller 78 slides up the first ramped portion 68A, the pin 76 moves upwardly within the second switch channel 62. The roller 78 continues to slide up the first ramped portion 54A until the roller 78 slides onto the peak 54C of the recess 54. The roller 78 is located on the peak 54C once the first traverse switch unit 22 and the second traverse switch unit 24 are aligned. While the roller 78 is located on the peak 54C, the pin 76 is lifted entirely out of the second switch channel 62. After the pin 76 is lifted entirely out of the second switch channel 62, the carriage 17 is free to move through the second switch channel 62.

The moveable rail 12 and the first traverse switch unit 22 may then be moved away from the fixed rail 14 and the second traverse switch unit 24 in the movement direction M. In this way, the roller 78 slides down the second ramped portion 54B of the recess 54 from the peak 54C. The pin 76 then moves downwardly into the second switch channel 62.

Because the shapes of the recesses 54, 68 are substantially similar, the movement of the pin 72 of the first carriage blocker 46 and the pin 76 of the second carriage blocker 60 occurs simultaneously. In this way, the first switch channel 48 and the second switch channel 62 become open and free for movement of the carriage 17 therethrough simultaneously. Once the traverse switch units 22, 24 are aligned, both pins 72, 76 move out of the respective switch channels 48, 62, and the carriage 17 is free to move between the moveable-rail channel 32, the first switch channel 48, the second switch channel 62, and the fixed-rail channel 36.

Turning to the indicator unit 26 of the traverse switch 20, the indicator unit 26 is configured to indicate proper alignment of the moveable rail 12 (and thus, the first traverse switch unit 22) with the fixed rail 14 (and thus, the second traverse switch unit 24) by mechanically producing the audible indicator after the moveable rail 12 is aligned with the fixed rail 14 so that the carriage 17 can be moved along the continuous-carriage channel 40 to move the patient. The indicator unit 26 is coupled to the first housing 42 such that the indicator unit 26 is located between the first cover 44 and the first housing 42 of the first traverse switch unit 22, as shown in FIG. 4.

The indicator unit 26 includes a lever assembly 80, a sound bracket 82, and a first spring 84, as shown in FIG. 4. The lever assembly 80 causes the sound bracket 82 to pivot about a bracket-pivot axis B. The sound bracket 82 pivots about the bracket-pivot axis B to produce the audible indicator. The first spring 84 extends between and interconnects the lever assembly 80 and the sound bracket 82 so that movement of the lever assembly 80 causes the sound bracket 82 to pivot.

The lever assembly 80 includes a lever 86, a roller 88, and a second spring 90, as shown in FIG. 4. The lever 86 is pivotably coupled to the first housing 42 at a first end 86A thereof. The lever 86 pivots about a lever-pivot axis A adjacent the first end 86A of the lever 86. The first spring 84 is coupled to a second end 86B of the lever 86 opposite the first end 86A thereof.

The roller 88 is coupled to the lever 86 around a mid-point of the lever 86, as shown in FIG. 4. The roller 88 moves upwardly in response to engagement with the second cover 58 to cause pivoting of the lever 86 about the lever-pivot axis A. The roller 88 extends outwardly from a slot formed in the first cover 44, as shown in FIG. 2. The roller 88 is located above the roller 74 of the first carriage blocker 46.

The second spring 90 is coupled to the lever 86 adjacent the roller 88, as shown in FIG. 4. The second spring 90 is also coupled to the first housing 42. The second spring 90 urges the lever 86 to rotate about the lever-pivot axis A.

The sound bracket 82 is located within a cavity 92 formed in the first housing 42, as shown in FIG. 4. The sound bracket 82 is pivotably coupled to the first housing 42 such that the sound bracket 82 pivots about the bracket-pivot axis B. The first spring 84 is coupled to a spring-connection point 94 of the sound bracket 82. The first spring 84, thus, extends between and interconnects the second end 86B of the lever 86 and the spring-connection point 94 of the sound bracket 82. The sound bracket 82 is fully enclosed and hidden within the first traverse switch unit 22 by the first cover 44, as shown in FIG. 2.

As the first traverse switch unit 22 moves toward the second traverse switch unit 24 in the movement direction M, the roller 88 of the lever assembly 80 slides along the first ramped portion 70A of the second recess 70 of the second cover 58, as shown in FIG. 6. As the roller 88 continues to slide upwardly along the first ramped portion 70A, the roller 88 lifts the lever 86 upwardly such that the lever 86 pivots in a first direction about the lever-pivot axis A, as shown in FIGS. 7 and 8. In some embodiments, the first direction may be a clockwise direction.

Due to the pivoting of the lever 86 in the first direction, the sound bracket 82 pivots about the bracket-pivot axis B in a second direction opposite the first direction, as shown in FIG. 8. In some embodiments, the second direction may be a counterclockwise direction. The pivoting of the lever 86 stretches the first spring 84 that interconnects the lever 86 and the sound bracket 82. Thus, after pivoting of the lever 86 in the first direction, the first spring 84 urges the sound bracket 82 to pivot in the second direction, as shown in FIG. 8.

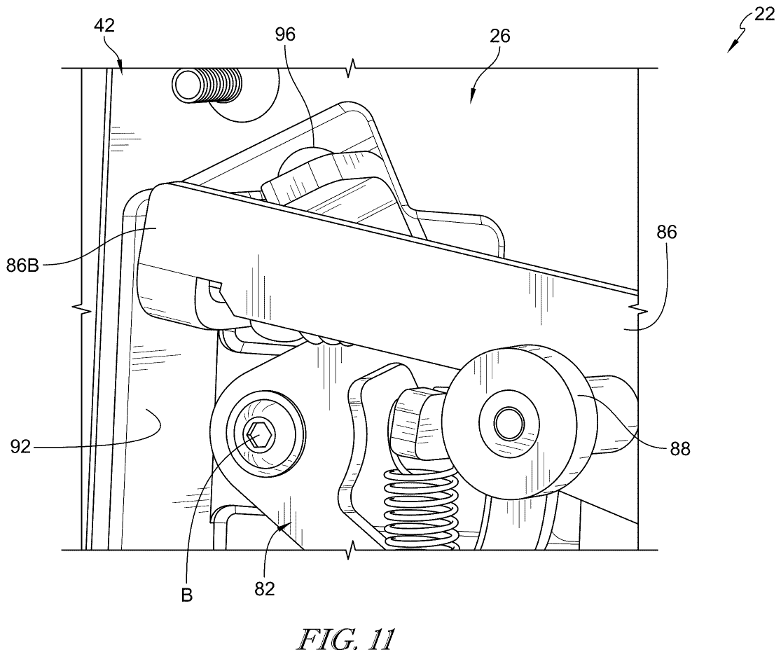

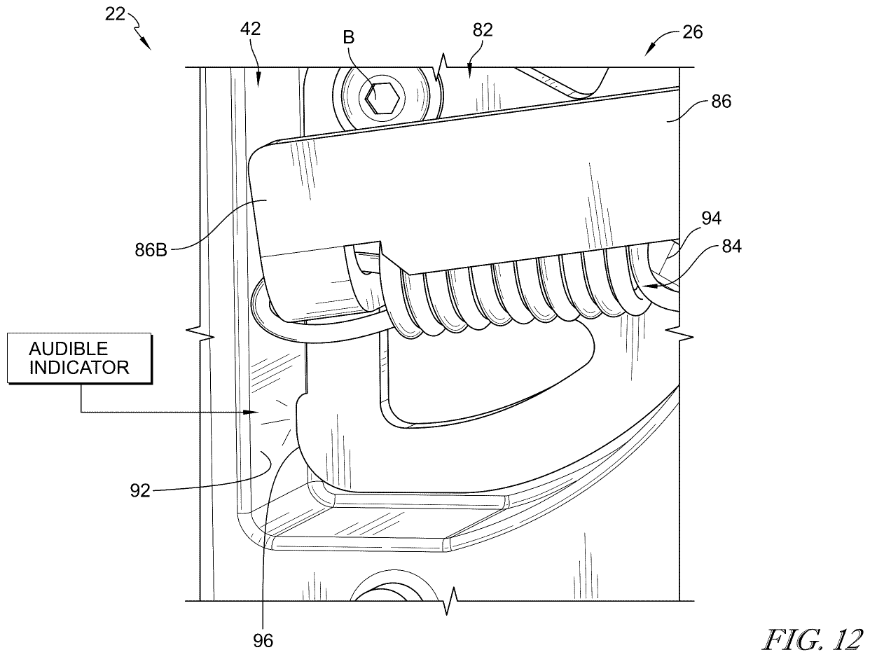

As shown in FIG. 11, once the sound bracket 82 pivots in the second direction, an upper edge 96 of the sound bracket 82 engages a wall of the first housing 42 defining a portion of the cavity 92. This engagement may produce a low decibel audible indicator that is not heard by the caregiver.

As the first traverse switch unit 22 continues to move toward the second traverse switch unit 24 in the movement direction M, the roller 88 of the lever assembly 80 slides into the trough 70C of the second recess 70 from the first ramped portion 70A, as shown in FIG. 9. As the roller 88 slides downwardly into the trough 70C, the roller 88 moves the lever 86 downwardly such that the lever 86 pivots in the second direction about the lever-pivot axis A. The second spring 90 urges the lever 86 to pivot about the lever-pivot axis A in the second direction.

Due to the pivoting of the lever 86 in the second direction, the sound bracket 82 pivots about the bracket-pivot axis B in the first direction, as shown in FIG. 10. The pivoting of the lever 86 stretches the first spring 84 that interconnects the lever 86 and the sound bracket 82. Thus, after pivoting of the lever 86 in the second direction, the first spring 84 urges the sound bracket 82 to pivot in the first direction, as shown in FIG. 10.

As shown in FIG. 12, once the sound bracket 82 pivots in the first direction, a lower edge 98 of the sound bracket 82 engages a wall of the first housing 42 defining a portion of the cavity 92. This engagement produces the audible indicator. The audible indicator has a higher decibel level than the low decibel audible indicator previously described. The lower edge 98 of the sound bracket 82 hits the wall of the first housing 42, and the contact between the sound bracket 82 and the first housing 42 creates the audible indicator to provide sound feedback (e.g., a click) to the caregiver. The audible indicator is substantially similar during all uses of the traverse switch 20. In other words, for example, the audible indicator is the same irrespective of how fast the moveable rail 12 is being moved toward the fixed rail 14.

As shown in FIGS. 6-10, the movement of the pins 72, 76 of the carriage blockers 46, 60 occurs simultaneously with the movement of the indicator unit 26. In some embodiments, the sound bracket 82 is made of sheet metal. In some embodiments, the first housing 42 is made of aluminum. In some embodiments, the first carriage blocker 46 and the second carriage blocker 60 form a carriage blocker unit. The indicator unit 26 is a wholly mechanical system that provides the audible indicator without electronics or power.

The overhead rail apparatus 10 further includes at least one fixation bracket 102, as shown in FIGS. 14 and 15. The at least one fixation bracket 102 is configured to couple the first or second traverse switch unit 22, 24 with the respective moveable or fixed rail 12, 14, as shown in FIG. 1. The overhead rail apparatus 10 may include rails 12, 14, 18 of different heights. For example, the rails 12, 14, 18 may have a height of 70 mm, 100 mm, or 140 mm. Further, the overhead rail apparatus 10 may include different rail carriers 30. The at least one fixation bracket 102 allows the traverse switch 20 to be usable with rails 12, 14, 18 of different heights and with different rail carriers 30. Thus, for different rails 12, 14, 18 or different rail carriers 30, different traverse switches are not necessary as the traverse switch 20 is adaptable to various configurations of rails 12, 14, 18 and rail carriers 30.

Traditional traverse switches are complicated to install and not adaptable to different rails or rail carriers. For example, traditional traverse switches may require machining of the rails during installation. Thus, the fixation bracket 102 is provided herein that allows for easy installation of the traverse switch 20 with the moveable and fixed rails 12, 14 and allows for the same traverse switch 20 to be used with different rails 12, 14, 18 and different rail carriers 30.

One fixation bracket 102 couples the first traverse switch unit 22 to the end of the moveable rail 12, and another fixation bracket 102 couples the second traverse switch unit 24 to the end of the fixed rail 14, as shown in FIG. 1. Each fixation bracket 102 includes a body 104, a plurality of fasteners 106, and a rail coupler 108, as shown in FIG. 14.

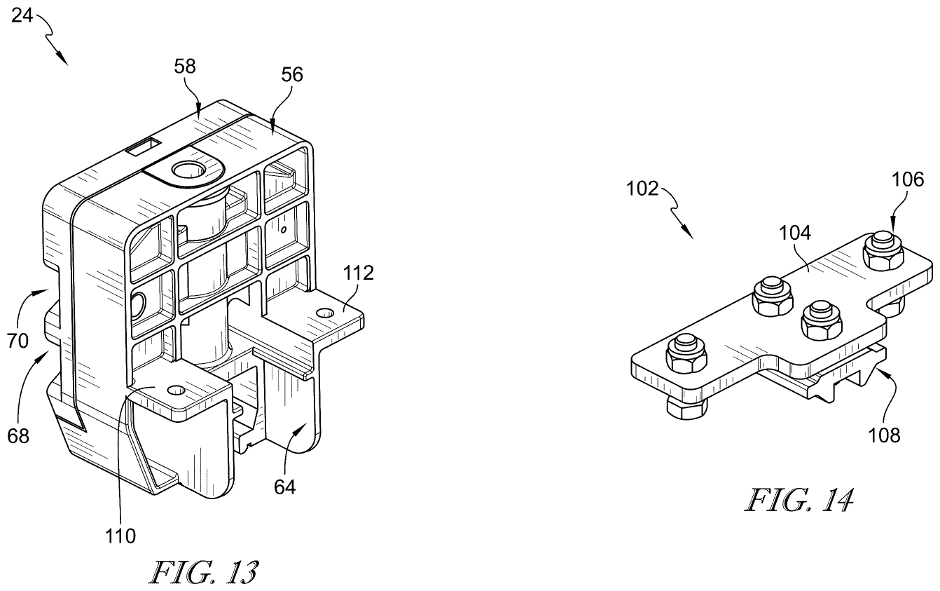

As shown in FIG. 13, the second traverse switch unit 24 includes a first flange 110 and a second flange 112. The first flange 110 extends outwardly from the second housing 56 in a direction opposite the second cover 58. The second flange 112 is spaced apart from the first flange 110 and extends outwardly from the second housing 56 in the direction opposite the second cover 58. As shown in FIG. 16, the first traverse switch unit 22 includes a first flange 114 and a second flange 116. The first flange 114 extends outwardly from the first housing 42 in a direction opposite the first cover 44. The second flange 116 is spaced apart from the first flange 114 and extends outwardly from the first housing 42 in the direction opposite the first cover 44.

The body 104 of the fixation bracket 102 engages the respective first flange 110, 114 and the respective second flange 112, 116 of the respective traverse switch unit 22, 24, as shown in FIG. 15. The body 104 is substantially flat and planar. The plurality of fasteners 106 extends through the body 104 and the respective first flange 110, 114 and the second flange 112, 116 to couple the fixation bracket 102 to the respective traverse switch unit 22, 24, as shown in FIG. 15. The plurality of fasteners 106 also extends through the body 104 and the rail coupler 108 to couple the body 104 and the rail coupler 108 to one another.

The rail coupler 108 of the fixation bracket 102 extends downwardly from the body 104, as shown in FIG. 14. The rail coupler 108 is received in the respective fixation-bracket channel 34, 38 of the respective moveable rail 12 or fixed rail 14. The rail coupler 108, thus, couples the traverse switch unit 22, 24 to the rail 12, 14. In some embodiments, the body 104 and the rail coupler 108 are formed of sheet metal steel.

A different fixation bracket 102′ is shown in FIG. 16. The fixation bracket 102′ allows the traverse switch 20 to be coupled to a different rail 12′. As compared to the moveable rail 12, the moveable rail 12′ has a greater height.

The fixation bracket 102′ includes a body 104′, a plurality of fasteners 106′, and a rail coupler 108′, as shown in FIG. 16. The body 104′ is illustratively non-planar, as shown in FIG. 16. The body 104′ includes a first portion 104A′, a second portion 104B′, and a third portion 104C′. The first portion 104A′ engages the first flange 114 of the first traverse switch unit 22. The third portion 104C′ engages the second flange 116 of the first traverse switch unit 22. The second portion 104B′ is located between and interconnects the first and third portions 104A′, 104C′. The first and third portions 104A′, 104C′ are substantially flat, while the second portion 104B′ extends upwardly to fit over the taller rail 12′. The second portion 104B′ includes a first wall 118′ coupled to the first portion 104A′, a second wall 120′ coupled to the first wall 118′, and a third wall 122′ coupled to the second wall 120′ and the third portion 104C′. The first portion 104A′, the third portion 104C′, and the second wall 120′ are substantially parallel to one another. The first wall 118′ and the third wall 122′ are substantially parallel to one another and perpendicular to the first portion 104A′, the third portion 104C′, and the second wall 120′.

The plurality of fasteners 106′ extends through the first portion 104A′ and the third portion 104C′ of the body 104′ and the respective first flange 114 and the second flange 116 to couple the fixation bracket 102′ to the first traverse switch unit 22. The plurality of fasteners 106′ also extends through the second wall 120′ of the second portion 104B′ of the body 104′ and the rail coupler 108′ to couple the body 104′ and the rail coupler 108′ to one another.

The rail coupler 108′ of the fixation bracket 102′ extends downwardly from the body 104′, as shown in FIG. 16. The rail coupler 108′ is received in a fixation-bracket channel 34′ of the moveable rail 12′. The rail coupler 108′, thus, couples the first traverse switch unit 22 to the moveable rail 12′. In some embodiments, the body 104′ and the rail coupler 108′ are formed of sheet metal steel. Though shown with the moveable rail 12′and the first traverse switch unit 22, the fixation bracket 102′ is also usable with a fixed rail having the same shape as the moveable rail 12′ and the second traverse switch unit 24.

Although certain illustrative embodiments have been described in detail above, variations and modifications exist within the scope and spirit of this disclosure as described and as defined in the following claims.

1. An overhead rail apparatus comprising:
a carriage configured to support a patient above underlying ground,
a fixed rail configured to be fixed to an overhead structure, the fixed rail formed to include a fixed-rail channel configured to receive the carriage therein so that the carriage can be moved along the fixed rail to move the patient,
a moveable rail configured to move relative to the fixed rail, the moveable rail formed to include a moveable-rail channel configured to receive the carriage therein so that the carriage can be moved along the moveable rail to move the patient, and
a traverse switch configured to align the moveable rail with the fixed rail so that the fixed-rail channel is aligned with the moveable-rail channel to form a continuous-carriage channel through which the carriage can be moved, the traverse switch including a first traverse switch unit coupled to an end of the moveable rail, a second traverse switch unit coupled to an end of the fixed rail, and an indicator unit configured to indicate proper alignment of the moveable rail with the fixed rail by mechanically producing an audible indicator after the moveable rail is aligned with the fixed rail so that the carriage can be moved along the continuous-carriage channel to move the patient.

2. The overhead rail apparatus of claim 1, wherein the indicator unit is coupled to the first traverse switch unit, and wherein the indicator unit includes a sound bracket, a lever assembly, and a first spring interconnecting the sound bracket and the lever assembly.

3. The overhead rail apparatus of claim 2, wherein the lever assembly includes a lever configured to pivot about a lever-pivot axis, a roller coupled to the lever and configured to move linearly to cause the lever to pivot about the lever-pivot axis, and a second spring coupled to the lever and the first traverse switch unit and configured to urge the lever to pivot about the lever-pivot axis.

4. The overhead rail apparatus of claim 3, wherein the lever is fixed to the first traverse switch unit at a first end thereof and configured to pivot about the lever-pivot axis relative to the first traverse switch unit such that a second end of the lever opposite the first end pivots.

5. The overhead rail apparatus of claim 4, wherein the second traverse switch unit is formed to include a first recess extending into the second traverse switch unit, the first recess having a first ramped portion, a second ramped portion, and a trough located between the first ramped portion and the second ramped portion.

6. The overhead rail apparatus of claim 5, wherein the lever pivots about the lever-pivot axis in a first direction in response to engagement of the roller of the lever assembly with the first ramped portion of the first recess of the second traverse switch unit to cause the roller to move vertically upwardly, and wherein the lever pivots about the lever-pivot axis in a second direction opposite the first direction in response to engagement of the roller of the lever assembly with the trough of the first recess of the second traverse switch unit to cause the roller to move vertically downwardly.

7. The overhead rail apparatus of claim 6, wherein the first spring urges the sound bracket to pivot about a bracket-pivot axis in the second direction in response to pivoting of the lever about the lever-pivot axis in the first direction, and wherein the first spring urges the sound bracket to pivot in the first direction about the bracket-pivot axis in response to pivoting of the lever about the lever-pivot axis in the second direction.

8. The overhead rail apparatus of claim 7, wherein, in response to pivoting of the sound bracket in the first direction, a lower end of the sound bracket contacts the first traverse switch unit to produce the audible indicator.

9. The overhead rail apparatus of claim 1, wherein the first traverse switch unit includes (i) a first housing coupled to the end of the moveable rail and formed to define a first switch channel that is aligned with the moveable-rail channel and (ii) a first carriage blocker configured to block movement of the carriage out of the moveable-rail channel while the moveable rail and the fixed rail are not properly aligned, the first carriage blocker including a pin that extends downwardly into the first switch channel to block movement of the carriage out of the moveable-rail channel while the moveable rail and the fixed rail are not properly aligned and a roller coupled to the pin of the first carriage blocker and configured to move the pin upwardly out of the first switch channel so that the carriage is free to move out of the moveable-rail channel and into the first switch channel while the moveable rail and the fixed rail are properly aligned.

10. The overhead rail apparatus of claim 9, wherein the second traverse switch unit is formed to include a second recess extending into the second traverse switch unit, the second recess having a first ramped portion, a second ramped portion, and a peak located between the first ramped portion of the second recess and the second ramped portion of the second recess, and wherein, in response to movement of the moveable rail relative to the fixed rail, the roller of the first carriage blocker moves along the first ramped portion of the second recess of the second traverse switch unit to the peak of the second recess of the second traverse switch unit to move the pin of the first carriage blocker upwardly out of the first switch channel.

11. An overhead rail apparatus comprising:
a fixed rail configured to be fixed to an overhead structure,
a moveable rail configured to move relative to the fixed rail, and
a traverse switch configured to align the moveable rail with the fixed rail, the traverse switch including a first traverse switch unit coupled to an end of the moveable rail, a second traverse switch unit coupled to an end of the fixed rail, and an indicator unit configured to indicate proper alignment of the moveable rail with the fixed rail by mechanically producing an audible indicator after the moveable rail is aligned with the fixed rail, the indicator unit including a sound bracket configured to produce the audible indicator and a lever assembly configured to cause the sound bracket to produce the audible indicator.

12. The overhead rail apparatus of claim 11, wherein the first traverse switch unit includes a first housing coupled to the end of the moveable rail and a first cover coupled to the first housing to locate the first housing between the first cover and the end of the moveable rail, and wherein the second traverse switch unit includes a second housing coupled to the end of the fixed rail and a second cover coupled to the second housing to locate the second housing between the second cover and the end of the fixed rail, and wherein the indicator unit is coupled to the first housing and located between the first housing and the first cover.

13. The overhead rail apparatus of claim 12, wherein the lever assembly includes a lever configured to pivot about a lever-pivot axis, a roller coupled to the lever and configured to move linearly to cause the lever to pivot about the lever-pivot axis, and a spring coupled to the lever and the first housing and configured to urge the lever to pivot about the lever-pivot axis, and wherein the lever is fixed to the first housing at a first end thereof and configured to pivot about the lever-pivot axis relative to the first housing and the first cover such that a second end of the lever opposite the first end pivots.

14. The overhead rail apparatus of claim 13, wherein the second cover of the second traverse switch unit is formed to include a first recess extending into the second cover toward the second housing, the first recess having a first ramped portion, a second ramped portion, and a trough located between the first ramped portion and the second ramped portion.

15. The overhead rail apparatus of claim 14, wherein the lever pivots about the lever-pivot axis in a first direction in response to engagement of the roller of the lever assembly with the first ramped portion of the first recess of the second traverse switch unit to cause the roller to move vertically upwardly, and wherein the lever pivots about the lever-pivot axis in a second direction opposite the first direction in response to engagement of the roller of the lever assembly with the trough of the first recess of the second traverse switch unit to cause the roller to move vertically downwardly.

16. The overhead rail apparatus of claim 13, wherein the sound bracket is configured to pivot in a second direction about a bracket-pivot axis in response to the lever of the lever assembly pivoting about the lever-pivot axis in a first direction opposite the second direction, and wherein the sound bracket is configured to pivot in the first direction about the bracket-pivot axis in response to the lever pivoting about the lever-pivot axis in the second direction.

17. The overhead rail apparatus of claim 16, wherein, in response to the sound bracket pivoting in the first direction, a lower end of the sound bracket contacts the first housing of the first traverse switch unit to produce the audible indicator.

18. A method comprising:
moving a moveable rail along a primary rail toward a fixed rail,
aligning a first traverse switch unit coupled to the moveable rail with a second traverse switch unit coupled to the fixed rail,
pivoting a lever coupled to the first traverse switch unit about a lever-pivot axis in a first direction,
in response to pivoting the lever about the lever-pivot axis in the first direction, pivoting a sound bracket coupled to the first traverse switch unit about a bracket-pivot axis in a second direction opposite the first direction,
pivoting the lever about the lever-pivot axis in the second direction,
in response to pivoting the lever about the lever-pivot axis in the second direction, pivoting the sound bracket about the bracket-pivot axis in the first direction, and
in response to pivoting the sound bracket about the bracket-pivot axis in the first direction, hitting a surface of the first traverse switch unit with the sound bracket to produce an audible indicator.

19. The method of claim 18, wherein pivoting a sound bracket coupled to the first traverse switch unit about a bracket-pivot axis in a second direction includes urging the sound bracket to pivot in the second direction via a first spring, and wherein pivoting the lever about the lever-pivot axis in the second direction includes urging the lever to pivot in the second direction via a second spring.

20. The method of claim 18, further comprising, after hitting a surface of the first traverse switch unit with the sound bracket to produce an audible indicator, moving a carriage between the moveable rail and the fixed rail.
